(19) United States
(12) Patent Application Publication
(10) Pub. No.: US 2023/0105491 A1
(43) Pub. Date: Apr. 6, 2023

(54) CLOUD SERVICE MESH PERFORMANCE TUNING

(71) Applicant: Intel Corporation, Santa Clara, CA (US)

(72) Inventors: Mrittika GANGULI, Chandler, AZ (US); Dmytro YERMOLENKO, Gdansk (PL); Adrian C. MOGA, Portland, OR (US); Abhirupa LAYEK, Chandler, AZ (US); Qiming LIU, Wuxi City (CN); Robert ZMUDA TRZEBIATOWSKI, Gdansk (PL); Rafal SZNEJDER, Gdansk (PL); Piotr WYSOCKI, Gdansk (PL); Mohan J. KUMAR, Aloha, OR (US); Ranganath SUNKU, Beaverton, OR (US); Vishakh NAIR, San Ramon, CA (US)

(21) Appl. No.: 18/073,920

(22) Filed: Dec. 2, 2022

(30) Foreign Application Priority Data
Oct. 21, 2022 (CN) PCT/CN2022/126680

(51) Int. Cl. H04L 47/70; H04L 47/78; H04L 47/80

(52) U.S. Cl. CPC H04L 47/826; H04L 47/781; H04L 47/803

(57) ABSTRACT

Examples described herein relate to a system to estimate latency of operations of a process without receiving a latency value directly based on received performance values and/or estimate throughput of packets transmitted for the process without receiving a throughput value directly based on received performance values. In some examples, the system is to request to adjust resource allocation to perform the process based on the determined latency and throughput.

### RELATED APPLICATION

This application claims the benefit of priority to Patent Cooperation Treaty (PCT) Application No. PCT/CN2022/126680, filed Oct. 21, 2022. The entire contents of that application are incorporated by reference.

### BACKGROUND

A service can be executed using a group of microservices executed on different servers. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), lightweight container or virtual machine deployment, and/or decentralized continuous microservice delivery.

Microservices can communicate with other microservices using packets transmitted over a network. Microservices can utilize a service mesh interface for observability, scaling, security policies and other management. The resources allocated to ingress proxies and sidecars (parts of a service mesh) and the traffic pattern can impact the performance of the microservice workload.

FIG. 1 depicts an example system. In this system, client 100 can issue a request to perform a workload to server 150 and receive results from workloads from server 150. Orchestrator 170 can receive key performance indicators (KPIs) to achieve for the workload from client 100 as well as performance monitoring information and adjust performance of server 150 to achieve KPIs. In this example, orchestrator 170 receives actual performance values and performs tuning using the actual performance values.

In Cloud Native environments, an important challenge is to increase a service mesh's operational efficiency while reducing its cost under a set of value constraints by dynamically determining an amount of resources (e.g., central processing unit (CPU) compute power, memory, networking bandwidth and others) which have to be assigned to the service mesh to meet service level agreements (SLAs). However, adjusting such resources may not improve service mesh operational efficiency. MeshMark is a performance index that measures the value and overhead of a cloud native environment that indicates overhead signals and KPIs as well as service mesh efficiency.

### BRIEF DESCRIPTION OF THE DRAWINGS

FIG. 1 depicts an example system.

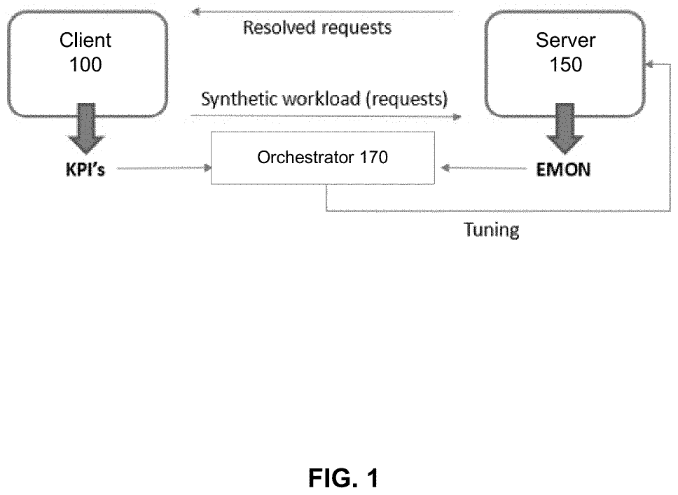

FIG. 2 depicts an example system.

FIG. 3 depicts an example process.

FIG. 4 depicts an example system.

FIG. 5 depicts an example system.

### DETAILED DESCRIPTION

Examples described herein can define one or more service mesh utilization efficiency (MUE) values to indicate resource utilization of a service mesh interface, as well as operating ratios which, when achieved, are likely to lead to achieving various target service mesh latencies and throughput (requests per second), and potentially other targets, as a service level objective (SLO) or SLA. In some examples, service mesh interface efficiency can be determined based on data analysis of metrics, and key performance indicators (KPIs) (e.g., latency and throughput) used to choose central processing unit (CPU) events that affect user experience and represent hardware usage effectiveness for an Intel Architecture (IA) platform or other CPU architecture. To choose metrics that represent microservices effectiveness correlation data analysis between metrics and KPIs (throughput and p99 latency) was performed.

To have a representative data set for correlation data analyses and calculation of microservice efficiently, a number of experiments have been done using Nighthawk benchmarking tool with different combinations of ingress and sidecar proxy attached to microservices and range of workload parameters (e.g., concurrency and number of connections). General calculation can be based on a sum of normalized effect of each collected metric:

$$M U E = 1 + {\sum }_{i = 0}^{N - 1} {k}_{i} M U {E}_{i} \to MIN ,$$

where
N can represent a number of metrics or metrics combinations that can be used for calculations for a case and
kᵢ can represent a weight coefficient.

In some cases, a minimum value of MUE is 1 is an ideal case that indicates microservices utilize 100% of assigned resources. An MUE number can be minimized to a level with acceptable KPIs. On the other hand, an MUE value can increase with increasing complexity of the task (number of metrics considered in calculations algorithm).

To reach a minimum value of MUE, components of the formula can be minimized and equals 0 in an ideal case. Various types of metrics can be applied for this purpose depending on metric value:
a) “Higher is better”—case when increasing metric value represents improving of Microservice Effectives (e.g., CPU utilization). To represent this affect in formula, the following can be used:

MUEᵢ=1−mᵢPᵢ,

where mᵢ—a metric or metrics combination value,
Pᵢ—normalization coefficient.
b) “Lower is better”—case when decreasing metric value represents improving of Microservice Effectives (e.g., cache misses):

MUEᵢ=mᵢPᵢ,

where mᵢ—a metric or metrics combination value,
Pᵢ—normalization coefficient.
In some cases, normalization coefficients can normalize metrics values in a range [0, 1].

Using metrics with high correlation level with latency provides a mathematical model based on machine learning to predict value of latency without measuring latency directly. For example, a range of metrics can be analyzed in terms of correlation (Pearson coefficient) with KPIs (throughput and p99 latency). Correlation pairs are shown in Table 1. Based on correlation data analysis several MUE ratios were proposed and calculated based on experimental data. Parameters of an experimental setup can be: Nighthawk v7.0 cfg3, 4client-4servers, no-idle=poll, turbo disabled, 12vCPU, 4vCPU-istio-sidecars, 16vCPU-istio-ing, ICX-ICX.

TABLE 1
Correlation of metrics with KPI collected on server side

| | Pearson coefficient | |
|---|---|---|
| | | rps |
| | | (requests |
| | | per |
| EMON metric | P99.99 | second) |
| metric_CPU utilization % in kernel mode | 0.309 | 0.722 |
| metric_L1D MPI (includes data + | 0.410 | 0.693 |
| rfo w/prefetches) | | |
| metric_L2 MPI (includes code + | 0.667 | 0.960 |
| data + rfo w/prefetches) | | |
| metric_LLC MPI (includes code + | −0.315 | −0.358 |
| data + rfo w/prefetches) | | |
| metric_memory RPQ PCH0 read latency (ns) | 0.228 | 0.684 |
| metric_memory RPQ PCH1 read latency (ns) | 0.024 | 0.286 |
| metric_memory WPQ PCH0 write latency (ns) | 0.409 | 0.855 |
| metric_memory WPQ PCH1 write latency (ns) | 0.520 | 0.880 |
| metric_IO_bandwidth_disk_or_network_writes | 0.594 | 0.999 |
| (MB/sec) | | |
| metric_IO_bandwidth_disk_or_network_reads | 0.608 | 1.000 |
| (MB/sec) | | |
| metric_TMA_Frontend_Bound(%) | 0.002 | 0.376 |
| metric_TMA_..Core_Bound(%) | −0.550 | −0.966 |
| INST_RETIRED.ANY | 0.406 | 0.805 |
| CORE_SNOOP_RESPONSE.RSP_IFWDFE | 0.376 | 0.826 |
| CORE_SNOOP_RESPONSE.RSP_IFWDM | 0.419 | 0.879 |
| CORE_SNOOP_RESPONSE.RSP_IHITFSE | 0.427 | 0.852 |
| CORE_SNOOP_RESPONSE.RSP_IHITI | 0.521 | 0.874 |
| CORE_SNOOP_RESPONSE.RSP_SFWDFE | 0.317 | 0.757 |
| CORE_SNOOP_RESPONSE.RSP_SFWDM | 0.625 | 0.996 |
| CORE_SNOOP_RESPONSE.RSP_SHITFSE | 0.471 | 0.859 |

Note that reference to EMON metrics can refer to a command-line tool that provides the ability to profile application and system performance, such that available from Intel®. Various events and metrics are described in https://perfmon-events.intel.com/. In some examples, EMON metrics can be available from registers or counters of a CPU. However, other manners of determining operating metrics can be used, as described herein such as AMD System Monitor or ARM Performance Monitoring Unit (PMU).

More generally, metrics utilized to determine MUE values can relate to one or more of: processor utilization, cache misses, memory read and write latencies, input output (IO) bandwidth to a central processing unit (CPU), IO bandwidth from the CPU, number of instructions retired, and/or core snoop responses.

In some examples, a MUE ratio “higher is better” based on CPU utilization can be represented as:

MUE₀=1−m₀P₀,

where m₀=metric_CPU utilization % in kernel mode,
P₀=0.01→CPU utilization in [0; 1] range.

In some examples, a MUE ratio “lower is better” based on cache misses can be represented as:

$$M U {E}_{1} = {P}_{1} {\sum }_{j = 1}^{3} {m}_{1}^{j} ,$$

where m₁¹=metric_L1D MPI (includes data+rfo (read for ownership) with prefetches),
m₁²=metric_L2 MPI (includes code+data+rfo with prefetches),
m₁³=metric_LLC MPI (includes code+data+rfo with prefetches), and
P₁=10→number of misses per 1000 instructions.

In some examples, MUE ratio “lower is better” based on memory read and write latencies can be represented as:

$$M U {E}_{2} = {P}_{2}^{1} {\sum }_{j = 1}^{2} {m}_{2}^{j} + {P}_{2}^{2} {\sum }_{j = 3}^{4} {m}_{2}^{j} ,$$

where
m₂¹=metric_memory RPQ PCH0 (e.g., read pending queue of chipset) read latency (ns),
m₂²=metric_memory RPQ PCH1 read latency (ns),
m₂³=metric_memory WPQ PCH0 write latency (e.g., write pending queue of chipset) (ns),
m₂⁴=metric_memory WPQ PCH1 write latency (ns).
P₂¹= 1/1000[ns], P₂²= 1/2500[ns],
Normalized maximum accepted can be: read latency 1 μs=1000 ns, write latency 2.5 μs=2500 ns.

In some examples, a MUE ratio “higher is better” based on total Input Output (IO) bandwidth (to and from CPU complex) can be represented as:

$$M U {E}_{3} = {P}_{3} {\sum }_{j = 1}^{2} {m}_{3}^{j} ,$$

where m₃¹=metric_IO_bandwidth_disk_or_network_writes (MB/sec),
m₃²=metric_IO_bandwidth_disk_or_network_reads (MB/sec).
P₃=8[Mb/MB]/10[Gb/sec]*1024[Mb/Gb]=0.00078125[Sec/MB], normalization to 10 Gb/s bandwidth.

In some examples, a MUE ratio based on metrics related to utilization of a front-end of a CPU pipeline and a core utilization (combined type of ratio “a+b”) can be represented as:

MUE₄=1−m₄¹P₄+m₄²P₄,

where m₄¹=metric_TMA_Frontend_Bound(%) “lower is better”,
m₄²=metric_TMA_..Core_Bound(%) “higher is better”,
P₄=0.01→both metrics in [0; 1] range.
An example of utilization of a front-end of a CPU can include fetching program code represented in architectural instructions and decoding fetched instructions into one or more hardware operations called micro-operations (uOps). The uOps can be provided to a back-end of the CPU in an allocation. The back-end can monitor when uOp's data operands are available and executing the uOp. The completion of a uOp's execution is called retirement and results of the uOp are written to registers or memory. A front-end stall can be caused by inability to fill a slot for execution with a uOp, and performance was front-end bound.

Core utilization and boundedness can be determined using events corresponding to utilization of execution units of the CPU, as opposed to allocation. Core bounded non-memory issues can arise due to shortage in hardware compute resources or dependencies software's instructions. Core boundedness can indicate certain execution units are overloaded or dependencies in program's data- or instruction-flow are limiting the performance.

In some examples, a MUE ratio “higher is better” based on number of instructions retired can be represented as:

MUE₅=1−m₅P₅,

where m₅=INST_RETIRED.ANY,
P₅=⅓*10⁻¹¹→normalized to 300 billion instructions based on experimental data.
m₅—can be normalized to number of cores and CPU frequency without changing level of correlations.

In some examples, MUE ratio “lower is better” based on core snoop responses can be represented as:

$$M U {E}_{6} = {P}_{6} {\sum }_{j = 1}^{7} {m}_{6}^{j} ,$$

where m₆¹=CORE_SNOOP_RESPONSE.RSP_IFWDFE,
m₆²=CORE_SNOOP_RESPONSE.RSP_IFWDM,
m₆³=CORE_SNOOP_RESPONSE.RSP_IHITFSE,
m₆⁴=CORE_SNOOP_RESPONSE.RSP_IHITI,
m₆⁵=CORE_SNOOP_RESPONSE.RSP_SFWDFE,
m₆⁶=CORE_SNOOP_RESPONSE.RSP_SFWDM,
m₆⁷=CORE_SNOOP_RESPONSE.RSP_SHITFSE,
P₆=⅓*10⁻⁹→normalized to 3 billion snoops.

Based on collected on different setups and workload parameters, values of MUE ratios were calculated with weight coefficient equal to 1 for MUE ratios. Table 2 provides a correlation analysis of obtained MUE's showing effect on KPIs for each MUE component.

TABLE 2
Correlation of MUE coefficient with KPIs collected on server side

| | Pearson coefficient | | |
|---|---|---|---|
| MUE ratios | Sqrt(P99.99) | P99.99 | rps |
| MUE₀ | −0.481 | −0.309 | −0.722 |
| MUE₁ | 0.729 | 0.595 | 0.913 |
| MUE₂ | 0.508 | 0.386 | 0.806 |
| MUE₃ | −0.710 | −0.598 | −0.999 |
| MUE₄ | 0.406 | 0.340 | 0.807 |
| MUE₅ | −0.575 | −0.406 | −0.805 |
| MUE₆ | 0.613 | 0.445 | 0.877 |

Various observations include the following. Reduction or minimization of MUE0 can increase p99 latency and throughput (rps). Reduction or minimization of MUE3 can increase p99 latency and throughput. Reduction or minimization of MUE5 can increase p99 latency and throughput. Reduction or minimization of MUE1 can decrease p99 latency and throughput. Reduction or minimization of MUE2 can decrease p99 latency and throughput. Reduction or minimization of MUE4 can decrease p99 latency and throughput. Reduction or minimization of MUE6 can decrease p99 latency and throughput.

Using MUE ratios, described herein, ratio effects on latency and throughput can be characterized as key performance indicators (KPIs) to predict latency and throughput values without measuring latency and throughput. In other words, proposed MUE ratios can be used to find system configuration to potentially achieve desired latency and throughput.

In some examples, KPIs were divided to 5 quantiles (ranges), although other numbers of ranges and ranges can be used. Referring to Table 3, for rules 1-5, MUE3 indicators are to be true to potentially achieve a predicted throughput.

TABLE 3
Requests per second (RPS) Tree 1 decision tree model rules

| Rule # | Indicator | Sign | Value | Predicted throughput (RPS) |
|---|---|---|---|---|
| 1 | MUE3 | < | 0.765 | from 400,000 (bigger than 400,000) |
| 2 | MUE3 | >= | 0.765 | from 300,000 to 400,000 |
| | &MUE3 | < | 0.900 | (between 300,000 and |
| | &MUE3 | < | 0.845 | 400,000) |
| | &MUE3 | < | 0.815 | |
| 3 | MUE3 | >= | 0.765 | from 250,000 to 300,000 |
| | &MUE3 | < | 0.900 | |
| | &MUE3 | < | 0.845 | |
| | &MUE3 | >= | 0.815 | |
| 4 | MUE3 | >= | 0.765 | from 150,000 to 250,000 |
| | &MUE3 | < | 0.900 | |
| | &MUE3 | >= | 0.845 | |
| 5 | MUE3 | >= | 0.765 | less than 150,000 |
| | &MUE3 | >= | 0.900 | |

Referring to Table 4, for rules 1-6, all indicators are to be true to potentially achieve a predicted latency.

TABLE 4
P99 Tree 1 decision tree rules

| | | | | P99 predicted |
|---|---|---|---|---|
| Rule # | Indicator | Sign | Value | latency (ms) |
| 1 | MUE3 | < | 0.775 | >=6.5 |
| 2 | MUE3 | >= | 0.775 | from 2.9 to 6.5 |
| | &MUE0 | < | 0.845 | |
| | &MUE5 | < | 0.706 | |
| 3 | MUE3 | >= | 0.775 | from 1.3 to 2.9 |
| | &MUE0 | < | 0.845 | |
| | &MUE5 | >= | 0.706 | |
| 4 | MUE3 | >= | 0.775 | from 1 to 1.3 |
| | &MUE0 | >= | 0.845 | |
| | &MUE0 | < | 0.890 | |
| 5 | MUE3 | >= | 0.775 | less than 1 |
| | &MUE0 | >= | 0.845 | |
| | &MUE0 | >= | 0.890 | |
| | &MUE3 | < | 0.945 | |
| 6 | MUE3 | >= | 0.775 | from 1 to 1.3 |
| | &MUE0 | >= | 0.845 | |
| | &MUE0 | >= | 0.890 | |
| | &MUE3 | >= | 0.945 | |

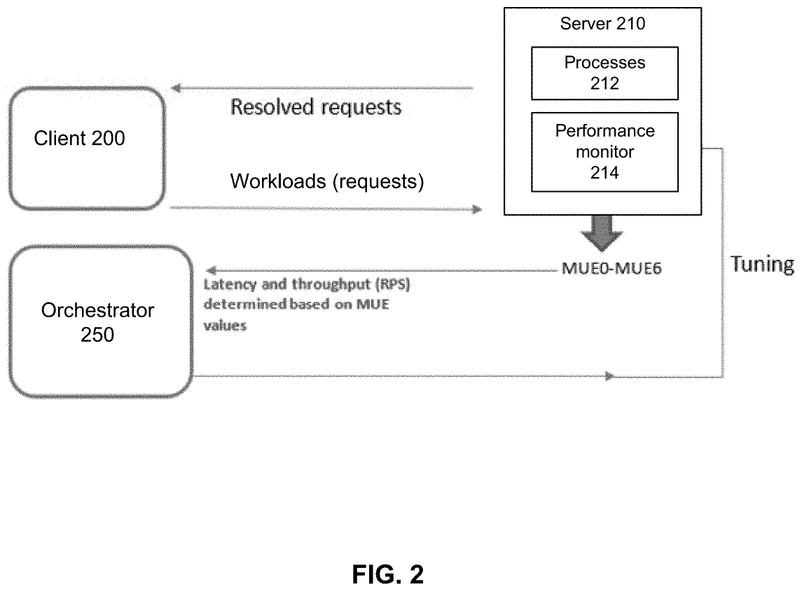

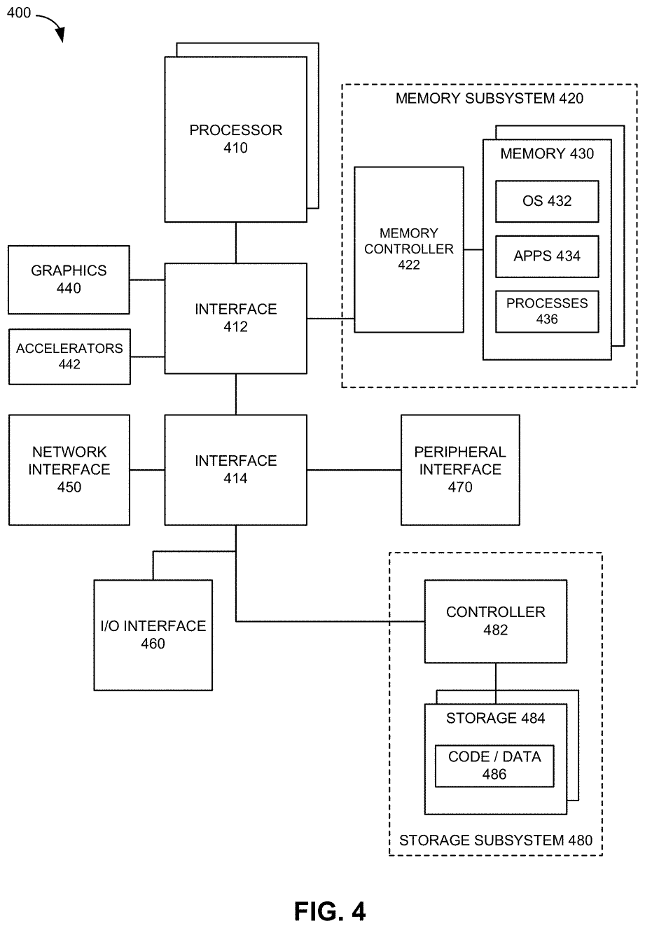

FIG. 2 depicts an example of evaluation and analysis of KPIs based on MUE values to adjust performance at least of a service mesh interface. Client 200 can include a server or other computing device that executes processes that issue requests to perform operations to server 210. Server 210 can execute processes 212 that can perform operations at the request of client 200 (e.g., database, webserver, content delivery network (CDN), or others). Various examples of client 200 and server 210 are described at least with respect to FIG. 4 and/or 5. Processes 212 can include one or more of: application, process, thread, a virtual machine (VM), microVM, container, microservice, or other virtualized execution environment. Note that application, process, thread, VM, microVM, container, microservice, or other virtualized execution environment can be used interchangeably. Processes 212 can include a service mesh interface, in some examples.

Microservices can utilize web proxies (e.g., service mesh interfaces) to intercept HTTP2 traffic. Hypertext Transfer Protocol (HTTP) is a generic, stateless, object-oriented application-level protocol that can be used for many tasks, such as name servers and distributed object management systems, through extension of its request methods (i.e., commands). A feature of HTTP is the typing of data representation (e.g., object types, data object types, etc.) that allow systems to be built independently of the data being transferred. Some commercial webservers use HTTP to execute webserver requests from client devices (e.g., Internet-enabled smartphones, tablets, laptop computers, desktop computers, Internet of Things (IoT) devices, edge devices, etc.). Some such webserver requests are for media, such as audio, video, and/or text-based media. Hypertext Transfer Protocol Secure (HTTPS) is the secure version of the HTTP protocol that uses the Secure Sockets Layer (SSL)/Transport Layer Security (TLS) protocol for encryption and authentication.

A service mesh can include an infrastructure layer for facilitating service-to-service communications between microservices using application programming interfaces (APIs). A service mesh interface can be implemented using a proxy instance (e.g., sidecar) to manage service-to-service communications. Some network protocols used by microservice communications include Layer 7 protocols, such as Hypertext Transfer Protocol (HTTP), HTTP/2, remote procedure call (RPC), gRPC, Kafka, MongoDB wire protocol, and so forth. Envoy Proxy is a well-known data plane for a service mesh. Istio, AppMesh, nginx, and Open Service Mesh (OSM) are examples of control planes for a service mesh data plane.

In some examples, data from performance monitoring circuitry 214 including counters or registers on server 210 can be provided to orchestrator 250. Such data can be used to determine MUE values (e.g., one or more of MUE0 to MUE6). In some examples, MUE values (e.g., one or more of MUE0 to MUE6) can be provided by performance monitoring circuitry 214 on server 210 to orchestrator 250. For example, data or MUE values can be provided by an EMON, counters, registers, Intel® Top-down Microarchitecture Analysis Method (TMAM), AMD uProf (“MICRO-prof”), AMD System Monitor, ARM Performance Monitoring Unit (PMU), or others. In some examples, MUE values can be based on data from counters, registers, or other monitors including Performance Monitoring Units (PMUs), Activity Monitoring Units (AMUs), or other circuitry.

Orchestrator 250 executing on server 210 or a different server can determine and predict latency without measuring latency directly and determine and predict throughput without measuring throughput directly based on received data or MUE values (e.g., one or more of MUE0 to MUE6). Orchestrator 250 can adjust resources allocated at least to perform operations of a service mesh interface on server 210 based on predicted latency and throughput. Some examples of orchestrator 250 include Kubernetes, Apache Mesos, Docker swarm scheduler, and so forth.

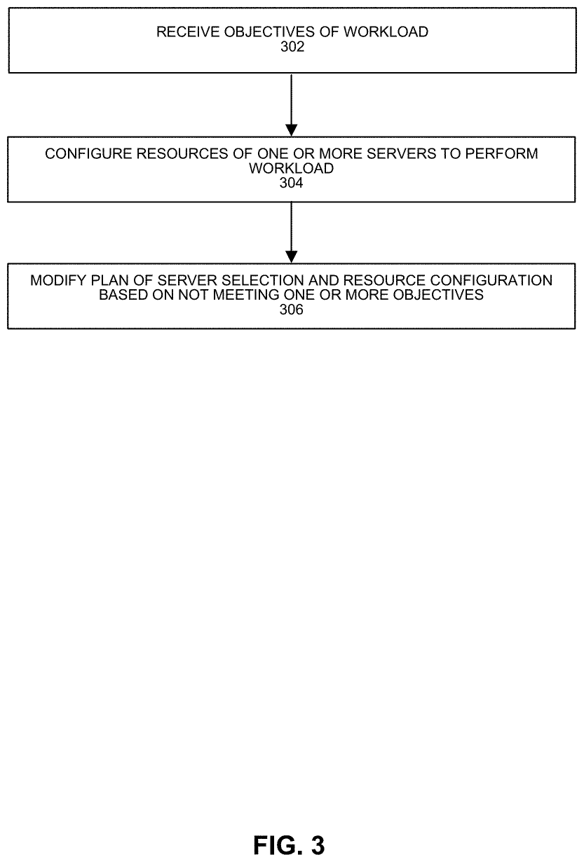

FIG. 3 depicts an example process to perform tuning of resource utilization to achieve latency or throughput to achieve an SLA or service level objective (SLO) at least of a service mesh interface. The process can be performed by an orchestrator in some examples. At 302, a set of objectives for a service mesh interface can be received. The set of objectives may include objectives based on of communications from a service mesh interface or microservice latency, throughput (e.g., operations per second performed by a service mesh interface or microservice), or availability of resources (e.g., amount of allocated memory, CPU frequency, number of CPU cores, and so forth). The set of objectives can be received from a client, administrator, or another orchestrator.

At 304, resources of one or more computing nodes can be selected and configured to perform the service mesh interface based on the set of objectives. For example, resources can include one or more of: allocated amount of memory, allocated memory bandwidth, allocated amount of storage, allocated network interface bandwidth, frequency of operation of a CPU, number of allocated CPU cores, type and number of allocated accelerators (e.g., encryption, decryption, queue manager, load balancer), or others. Resources can be available in a server or in a composite node.

For example, a workload plan may be determined using an Anytime Dynamic A* search algorithm (e.g., R. Zhou and E. A. Hansen, “Multiple sequence alignment using A*,” In Proc. of the National Conference on Artificial Intelligence (AAAI), 2002) to determine a set of actions that may fulfill the objectives for the workload. For example, this may use a graph model in which the nodes represent the states the objectives are in and the edges are actions that may be triggered. To generate the successor states of a given state, the models that describe the effects of an action may be used to predict the follow-up states. When or after a state graph is completed, a search may be performed. The weight of the graph edges, indicating the actions, may be determined using utility functions and multiple attribute utility theory (MAUT). A shortest path between the current state and goal state, or objective, based on these weights/utilities may determine the plan.

The plan models can be based on actions and the resulting effects. Plan models may apply differently to different platforms and the features available on each platform. The plan models may be generated with Bayesian optimization using actions and associated effects. The plan models may be generated using machine learning with actions and associated effects used to train the machine learning model. The plan and the effect associated with actions can be stored in a database or other data structure or updated. A database may include previous actions and result effects, including platforms and configuration associated with each of the actions. This stored data may be used to generate the plan models.

At 306, based on failure to meet one or more of the set of objectives for the service mesh interface, a set of actions can be determine to alter the plan model. For example, latency of operations of the service mesh interface can be determined without measuring latency directly based on received performance values (e.g., one or more MUE values). For example, throughput of packets transmitted for the service can be determined without measuring throughput directly based on received performance values (e.g., one or more MUE values). In some examples, one or more MUE values can be based on one or more of: metrics utilized to determine MUE values can relate to one or more of: processor utilization, cache misses, memory read and write latencies, input output (IO) bandwidth to a central processing unit (CPU), IO bandwidth from the CPU, number of instructions retired, and/or core snoop responses. As the service mesh interface executes, based on determination that one or more of the objectives are not being met based on one or more MUEs, the plan may be adjusted to attempt to cause the set of objectives to be met. Utilizing stored models, actions from the plan models may be identified for updating the plan to meet the objectives. For example, adjusting the plan can cause adjustment of resources allocated to perform the service mesh interface.

FIG. 4 depicts a system. The system can use embodiments described herein to generate data of MUE values and configure hardware and/or software of system 400 based on one or more MUE values, as described herein. For example, processor 410, graphics 440, accelerators 442, or other devices can include circuitry to monitor performance and provide performance data and/or MUE to an orchestrator to determine whether performance of a service mesh interface is met or to adjust resource allocation for the service mesh interface.

System 500 includes processors 410, which provides processing, operation management, and execution of instructions for system 400. Processors 410 can include any type of microprocessor, central processing unit (CPU), graphics processing unit (GPU), XPU, processing core, or other processing hardware to provide processing for system 400, or a combination of processors. An XPU can include one or more of: a CPU, a graphics processing unit (GPU), general purpose GPU (GPGPU), and/or other processing units (e.g., accelerators or programmable or fixed function FPGAs). Processors 410 controls the overall operation of system 400, and can be or include, one or more programmable general-purpose or special-purpose microprocessors, digital signal processors (DSPs), programmable controllers, application specific integrated circuits (ASICs), programmable logic devices (PLDs), or the like, or a combination of such devices. Processors 410 can include one or more processor sockets.

In some examples, interface 412 and/or interface 414 can include a switch (e.g., CXL switch) that provides device interfaces between processors 410 and other devices (e.g., memory subsystem 420, graphics 440, accelerators 442, network interface 450, and so forth). Connections provide between a processor socket of processors 410 and one or more other devices can be configured by a switch controller, as described herein.

In one example, system 400 includes interface 412 coupled to processors 410, which can represent a higher speed interface or a high throughput interface for system components that needs higher bandwidth connections, such as memory subsystem 420 or graphics interface components 440, or accelerators 442. Interface 412 represents an interface circuit, which can be a standalone component or integrated onto a processor die.

Accelerators 442 can be a programmable or fixed function offload engine that can be accessed or used by a processors 410. For example, an accelerator among accelerators 442 can provide compression (DC) capability, cryptography services such as public key encryption (PKE), cipher, hash/authentication capabilities, decryption, or other capabilities or services. In some embodiments, in addition or alternatively, an accelerator among accelerators 442 provides field select controller capabilities as described herein. In some cases, accelerators 442 can be integrated into a CPU socket (e.g., a connector to a motherboard or circuit board that includes a CPU and provides an electrical interface with the CPU). For example, accelerators 442 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 442 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 420 represents the main memory of system 400 and provides storage for code to be executed by processors 410, or data values to be used in executing a routine. Memory subsystem 420 can include one or more memory devices 430 such as read-only memory (ROM), flash memory, one or more varieties of random access memory (RAM) such as DRAM, or other memory devices, or a combination of such devices. Memory 430 stores and hosts, among other things, operating system (OS) 432 to provide a software platform for execution of instructions in system 400. Additionally, applications 434 can execute on the software platform of OS 432 from memory 430. Applications 434 represent programs that have their own operational logic to perform execution of one or more functions. Applications 434 and/or processes 436 can refer instead or additionally to a virtual machine (VM), container, microservice, processor, or other software. Processes 436 represent agents or routines that provide auxiliary functions to OS 432 or one or more applications 434 or a combination. In some examples, applications 434 and/or processes 436 can refer to a service mesh interface.

OS 432, applications 434, and processes 436 provide software logic to provide functions for system 400. In one example, memory subsystem 420 includes memory controller 422, which is a memory controller to generate and issue commands to memory 430. It will be understood that memory controller 422 could be a physical part of processors 410 or a physical part of interface 412. For example, memory controller 422 can be an integrated memory controller, integrated onto a circuit with processors 410.

In some examples, OS 432 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on one or more processors sold or designed by Intel®, ARM®, AMD®, Qualcomm®, IBM®, Nvidia®, Broadcom®, Texas Instruments®, among others.

While not specifically illustrated, it will be understood that system 400 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 400 includes interface 414, which can be coupled to interface 412. In one example, interface 414 represents an interface circuit, which can include standalone components and integrated circuitry. In one example, multiple user interface components or peripheral components, or both, couple to interface 414. Network interface 450 provides system 400 the ability to communicate with remote devices (e.g., servers or other computing devices) over one or more networks. Network interface 450 can include an Ethernet adapter, wireless interconnection components, cellular network interconnection components, USB (universal serial bus), or other wired or wireless standards-based or proprietary interfaces. Network interface 450 can transmit data to a device that is in the same data center or rack or a remote device, which can include sending data stored in memory. Network interface 450 can receive data from a remote device, which can include storing received data into memory.

In some examples, network interface 450 can be implemented as a network interface controller, network interface card, a host fabric interface (HFI), or host bus adapter (HBA), and such examples can be interchangeable. Network interface 450 can be coupled to one or more servers using a bus, PCIe, CXL, or DDR. Network interface 450 may be embodied as part of a system-on-a-chip (SoC) that includes one or more processors, or included on a multichip package that also contains one or more processors.

Some examples of network device 450 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Network device 450 can include a programmable processing pipeline or offload circuitries that is programmable by P4, Software for Open Networking in the Cloud (SONiC), Broadcom® Network Programming Language (NPL), NVIDIA® CUDA®, NVIDIA® DOCA™, Data Plane Development Kit (DPDK), OpenDataPlane (ODP), Infrastructure Programmer Development Kit (IPDK), eBPF, x86 compatible executable binaries or other executable binaries. A programmable processing pipeline can include one or more match-action units (MAUs) that are configured based on a programmable pipeline language instruction set. Processors, FPGAs, other specialized processors, controllers, devices, and/or circuits can be used utilized for packet processing or packet modification. Ternary content-addressable memory (TCAM) can be used for parallel match-action or look-up operations on packet header content.

In one example, system 400 includes one or more input/output (I/O) interface(s) 460. I/O interface 460 can include one or more interface components through which a user interacts with system 400 (e.g., audio, alphanumeric, tactile/touch, or other interfacing). Peripheral interface 470 can include any hardware interface not specifically mentioned above. Peripherals refer generally to devices that connect dependently to system 400. A dependent connection is one where system 400 provides the software platform or hardware platform or both on which operation executes, and with which a user interacts.

In one example, system 400 includes storage subsystem 480 to store data in a nonvolatile manner. In one example, in certain system implementations, at least certain components of storage 480 can overlap with components of memory subsystem 420. Storage subsystem 480 includes storage device(s) 484, which can be or include any conventional medium for storing large amounts of data in a nonvolatile manner, such as one or more magnetic, solid state, or optical based disks, or a combination. Storage 484 holds code or instructions and data 486 in a persistent state (e.g., the value is retained despite interruption of power to system 400). Storage 484 can be generically considered to be a “memory,” although memory 430 is typically the executing or operating memory to provide instructions to processors 410. Whereas storage 484 is nonvolatile, memory 430 can include volatile memory (e.g., the value or state of the data is indeterminate if power is interrupted to system 400). In one example, storage subsystem 480 includes controller 482 to interface with storage 484. In one example controller 482 is a physical part of interface 414 or processors 410 or can include circuits or logic in processors 410 and interface 414.

In an example, system 400 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as Non-volatile Memory Express (NVMe) over Fabrics (NVMe-oF) or NVMe.

In some examples, system 400 can be implemented using interconnected compute nodes of processors, memories, storages, network interfaces, and other components. High speed interconnects can be used such as PCIe, Ethernet, or optical interconnects (or a combination thereof).

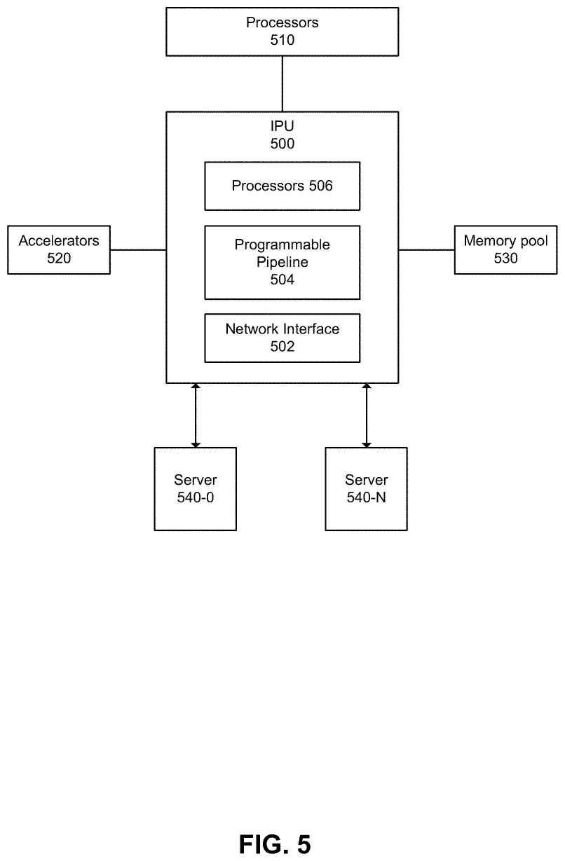

FIG. 5 depicts an example server system based on an IPU. In some examples, devices can execute a microservice and/or service mesh interface and latency and utilization of the service mesh interface can be determined based on one or more MUE values and adjusted, as described herein. For example, processors 506, processors 510, pipeline 504, accelerators 520, or other devices can include circuitry to monitor performance and provide performance data and/or MUE to an orchestrator to determine whether performance of a service mesh interface is met or to adjust resource allocation for the service mesh interface.

In this system, IPU 500 manages performance of one or more processes using one or more of processors 506, processors 510, accelerators 520, memory pool 530, or servers 540-0 to 540-N, where N is an integer of 1 or more. In some examples, processors 506 of IPU 500 can execute one or more processes, applications, VMs, containers, microservices, and so forth that request performance of workloads by one or more of: processors 510, accelerators 520, memory pool 530, and/or servers 540-0 to 540-N. IPU 500 can utilize network interface 502 or one or more device interfaces to communicate with processors 510, accelerators 520, memory pool 530, and/or servers 540-0 to 540-N. IPU 500 can utilize programmable pipeline 504 to process packets that are to be transmitted from network interface 502 or packets received from network interface 502.

Embodiments herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

Illustrative examples of the devices, systems, and methods disclosed herein are provided below. An embodiment of the devices, systems, and methods may include any one or more, and any combination of, the examples described below.

Flow diagrams as illustrated herein provide examples of sequences of various process actions. The flow diagrams can indicate operations to be executed by a software or firmware routine, as well as physical operations. In some embodiments, a flow diagram can illustrate the state of a finite state machine (FSM), which can be implemented in hardware and/or software. Although shown in a particular sequence or order, unless otherwise specified, the order of the actions can be modified. Thus, the illustrated embodiments should be understood only as an example, and the process can be performed in a different order, and some actions can be performed in parallel. Additionally, one or more actions can be omitted in various embodiments; thus, not all actions are required in every embodiment. Other process flows are possible.

Example 1 includes one or more examples and includes a computer-readable medium comprising instructions stored thereon, that if executed by one or more processors, cause the one or more processors to: determine latency of operations of a process without receiving a latency value directly based on received performance values; determine throughput of packets transmitted for the process without receiving a throughput value directly based on received performance values; and request to adjust resource allocation to perform the process based on the determined latency and throughput.

Example 2 includes one or more examples, wherein the performance values are based on one or more of: processor utilization, cache misses, memory read and write latencies, input output (IO) bandwidth to a central processing unit (CPU), IO bandwidth from the CPU, number of instructions retired, and/or core snoop responses.

Example 3 includes one or more examples, wherein the performance values are based on one or more of: fetching and providing decoding fetched instructions into hardware operations and/or unavailability of hardware compute resources of a central processing unit (CPU).

Example 4 includes one or more examples, wherein the request to adjust resource allocation to perform the process based on the determined latency and throughput comprises request cloud service mesh interface performance tuning based on memory utilization, cache misses, input/output bandwidth, and snoop ratios.

Example 5 includes one or more examples, wherein the process comprises a service mesh interface.

Example 6 includes one or more examples, wherein the performance values comprise latency and throughput of a service mesh interface.

Example 7 includes one or more examples, wherein the performance values are provided from one or more counters or registers of at least one server.

Example 8 includes one or more examples and includes an apparatus comprising: at least one memory and at least one processor, wherein based on execution of one or more instructions stored by the at least one memory, the at least one processor is to: determine latency of operations of a process without measuring latency directly based on received performance values; determine throughput of packets transmitted for the process without measuring throughput directly based on received performance values; and request to adjust resource allocation to perform the process based on the determined latency and throughput.

Example 9 includes one or more examples, wherein the performance values are based on one or more of: processor utilization, cache misses, memory read and write latencies, input output (IO) bandwidth to a central processing unit (CPU), IO bandwidth from the CPU, number of instructions retired, and/or core snoop responses.

Example 10 includes one or more examples, wherein the performance values are based on one or more of: fetching and providing decoding fetched instructions into hardware operations and/or unavailability of hardware compute resources of a central processing unit (CPU).

Example 11 includes one or more examples, wherein the request to adjust resource allocation to perform the process based on the determined latency and throughput comprises request cloud service mesh interface performance tuning based on memory utilization, cache misses, input/output bandwidth, and snoop ratios.

Example 12 includes one or more examples, wherein the process comprises a service mesh interface.

Example 13 includes one or more examples, wherein the performance values comprise latency and throughput of a service mesh interface.

Example 14 includes one or more examples, wherein the performance values are provided from one or more counters or registers of a server.

Example 15 includes one or more examples, and includes a network interface device and comprising circuitry to store monitored performance values of the network interface device, the at least one memory and the at least one processor.

Example 16 includes one or more examples, and includes a method comprising: determining latency of operations of a service mesh interface without measuring latency directly based on received performance values; determining throughput of packets transmitted for the service mesh interface without measuring throughput directly based on received performance values; and requesting to adjust resource allocation to perform the service mesh interface based on the determined latency and throughput.

Example 17 includes one or more examples, wherein the performance values are based on one or more of: processor utilization, cache misses, memory read and write latencies, input output (IO) bandwidth to a central processing unit (CPU), IO bandwidth from the CPU, number of instructions retired, and/or core snoop responses.

Example 18 includes one or more examples, wherein the performance values are based on one or more of: fetching and providing decoding fetched instructions into hardware operations and/or unavailability of hardware compute resources of a central processing unit (CPU).

Example 19 includes one or more examples, wherein the requesting to adjust resource allocation to perform the service mesh interface based on the determined latency and throughput comprises requesting cloud service mesh interface performance tuning based on memory utilization, cache misses, input/output bandwidth, and snoop ratios.

Example 20 includes one or more examples, wherein the performance values are provided from one or more counters or registers of at least one server.

What is claimed is:

1. A computer-readable medium comprising instructions stored thereon, that if executed by one or more processors, cause the one or more processors to:
determine latency of operations of a process without receiving a latency value directly based on received performance values;
determine throughput of packets transmitted for the process without receiving a throughput value directly based on received performance values; and
request to adjust resource allocation to perform the process based on the determined latency and throughput.

2. The computer-readable medium of claim 1, wherein the performance values are based on one or more of:
processor utilization, cache misses, memory read and write latencies, input output (IO) bandwidth to a central processing unit (CPU), IO bandwidth from the CPU, number of instructions retired, and/or core snoop responses.

3. The computer-readable medium of claim 1, wherein the performance values are based on one or more of: fetching and providing decoding fetched instructions into hardware operations and/or unavailability of hardware compute resources of a central processing unit (CPU).

4. The computer-readable medium of claim 1, wherein the request to adjust resource allocation to perform the process based on the determined latency and throughput comprises request cloud service mesh interface performance tuning based on memory utilization, cache misses, input/output bandwidth, and snoop ratios.

5. The computer-readable medium of claim 1, wherein the process comprises a service mesh interface.

6. The computer-readable medium of claim 1, wherein the performance values comprise latency and throughput of a service mesh interface.

7. The computer-readable medium of claim 1, wherein the performance values are provided from one or more counters or registers of at least one server.

8. An apparatus comprising:
at least one memory and
at least one processor, wherein based on execution of one or more instructions stored by the at least one memory, the at least one processor is to:
determine latency of operations of a process without measuring latency directly based on received performance values;
determine throughput of packets transmitted for the process without measuring throughput directly based on received performance values; and
request to adjust resource allocation to perform the process based on the determined latency and throughput.

9. The apparatus of claim 8, wherein the performance values are based on one or more of:
processor utilization, cache misses, memory read and write latencies, input output (IO) bandwidth to a central processing unit (CPU), IO bandwidth from the CPU, number of instructions retired, and/or core snoop responses.

10. The apparatus of claim 8, wherein the performance values are based on one or more of: fetching and providing decoding fetched instructions into hardware operations and/or unavailability of hardware compute resources of a central processing unit (CPU).

11. The apparatus of claim 8, wherein the request to adjust resource allocation to perform the process based on the determined latency and throughput comprises request cloud service mesh interface performance tuning based on memory utilization, cache misses, input/output bandwidth, and snoop ratios.

12. The apparatus of claim 8, wherein the process comprises a service mesh interface.

13. The apparatus of claim 8, wherein the performance values comprise latency and throughput of a service mesh interface.

14. The apparatus of claim 8, wherein the performance values are provided from one or more counters or registers of a server.

15. The apparatus of claim 8, comprising a network interface device and comprising circuitry to store monitored performance values of the network interface device, the at least one memory and the at least one processor.

16. A method comprising:
determining latency of operations of a service mesh interface without measuring latency directly based on received performance values;
determining throughput of packets transmitted for the service mesh interface without measuring throughput directly based on received performance values; and
requesting to adjust resource allocation to perform the service mesh interface based on the determined latency and throughput.

17. The method of claim 16, wherein the performance values are based on one or more of:
processor utilization, cache misses, memory read and write latencies, input output (IO) bandwidth to a central processing unit (CPU), IO bandwidth from the CPU, number of instructions retired, and/or core snoop responses.

18. The method of claim 16, wherein the performance values are based on one or more of: fetching and providing decoding fetched instructions into hardware operations and/or unavailability of hardware compute resources of a central processing unit (CPU).

19. The method of claim 16, wherein the requesting to adjust resource allocation to perform the service mesh interface based on the determined latency and throughput comprises requesting cloud service mesh interface performance tuning based on memory utilization, cache misses, input/output bandwidth, and snoop ratios.

20. The method of claim 16, wherein the performance values are provided from one or more counters or registers of at least one server.
